(19) United States
(12) Patent Application Publication
(10) Pub. No.: US 2019/0236978 A1
(43) Pub. Date: Aug. 1, 2019

(54) EDUCATIONAL DOLL ASSEMBLY

(71) Applicant: Marcinda Falls, Corona, CA (US)

(72) Inventor: Marcinda Falls, Corona, CA (US)

(21) Appl. No.: 15/884,478

(22) Filed: Jan. 31, 2018

(51) Int. Cl. G09B 19/06; H04R 1/02; H04R 3/00; A63H 3/00; A63H 3/28; G09B 5/04; A63H 3/36; A63H 3/12

(52) U.S. Cl. CPC G09B 19/06; H04R 1/028; H04R 3/00; A63H 3/003; A63H 2200/00; G09B 5/04; A63H 3/365; A63H 3/12; A63H 3/28

(57) ABSTRACT

An educational doll assembly includes a doll that has a body, a neck extending upwardly from the body and a head that is movably coupled to the neck. The neck extends upwardly into the head such that the head is rotatable about the neck. The head has a plurality of faces thereon and each of the faces is structured to resemble different ethnicities of human beings. The head is rotatable such that a selected one of the faces is aligned with the body of the doll. An audio unit is coupled to the doll and the audio unit stores a plurality of spoken words in a plurality of different languages. The audio unit emits the spoken words in a language corresponding to the ethnicity of the selected face on the head. In this way the audio unit teaches a user about the language spoken by the ethnicity on the selected face.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to doll devices and more particularly pertains to a new doll device for speaking a plurality of languages corresponding to selected ethnicities.

### BRIEF SUMMARY OF THE INVENTION

An embodiment of the disclosure meets the needs presented above by generally comprising a doll that has a body, a neck extending upwardly from the body and a head that is movably coupled to the neck. The neck extends upwardly into the head such that the head is rotatable about the neck. The head has a plurality of faces thereon and each of the faces is structured to resemble different ethnicities of human beings. The head is rotatable such that a selected one of the faces is aligned with the body of the doll. An audio unit is coupled to the doll and the audio unit stores a plurality of spoken words in a plurality of different languages. The audio unit emits the spoken words in a language corresponding to the ethnicity of the selected face on the head. In this way the audio unit teaches a user about the language spoken by the ethnicity on the selected face.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front phantom view of an educational doll assembly according to an embodiment of the disclosure.

FIG. 2 is a cut-away view of an embodiment of the disclosure.

FIG. 3 is a right side view of an embodiment of the disclosure.

FIG. 4 is a top view of an embodiment of the disclosure.

FIG. 5 is a top perspective view of an embodiment of the disclosure.

FIG. 6 is a schematic view of an embodiment of the disclosure.

### DETAILED DESCRIPTION OF THE INVENTION

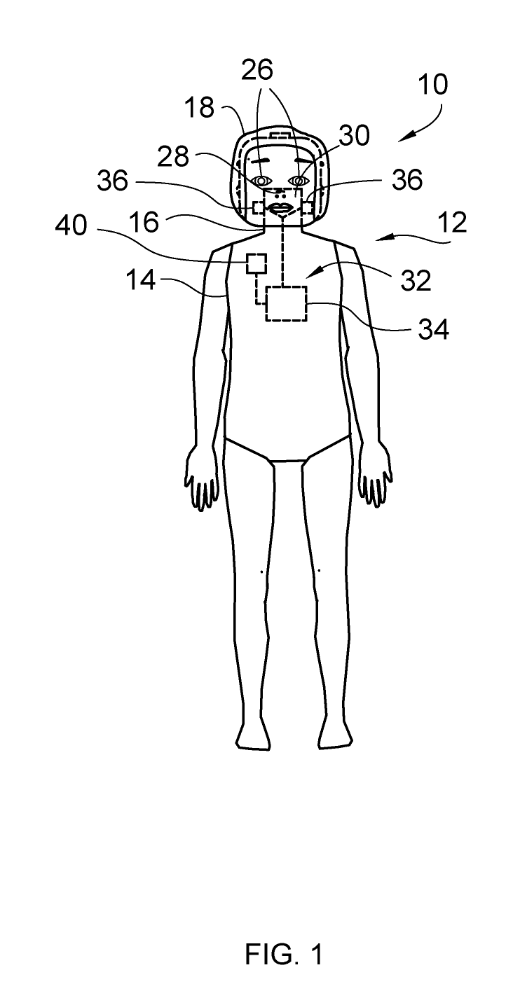

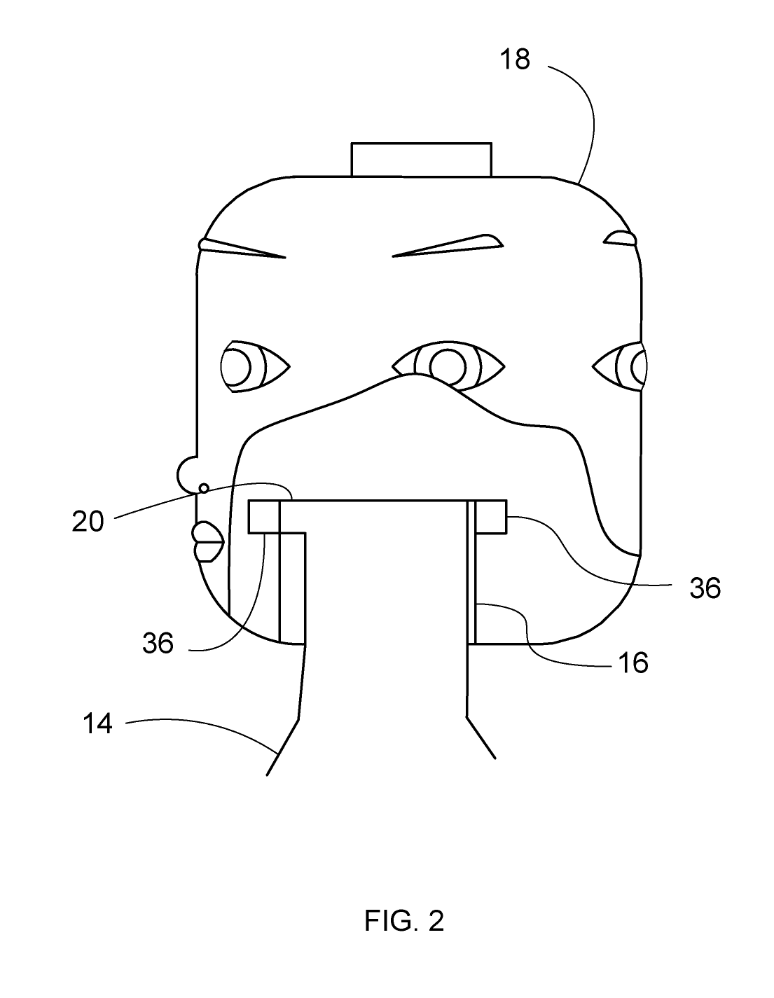

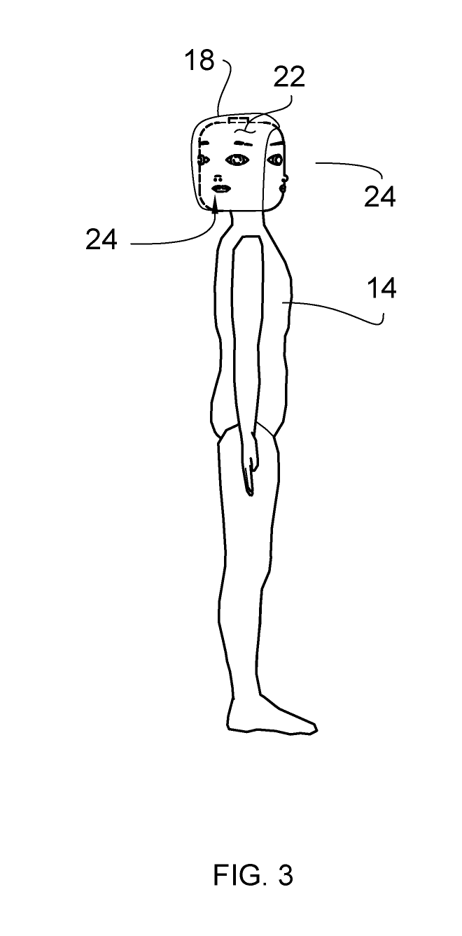

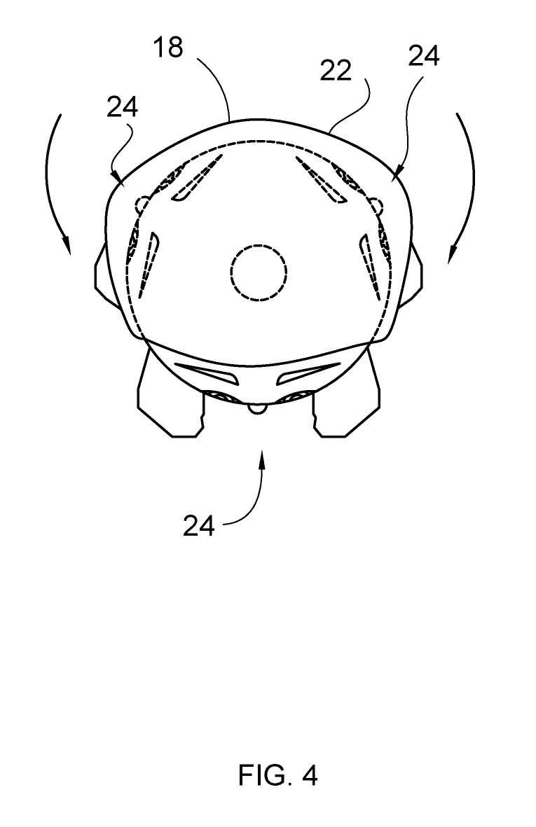

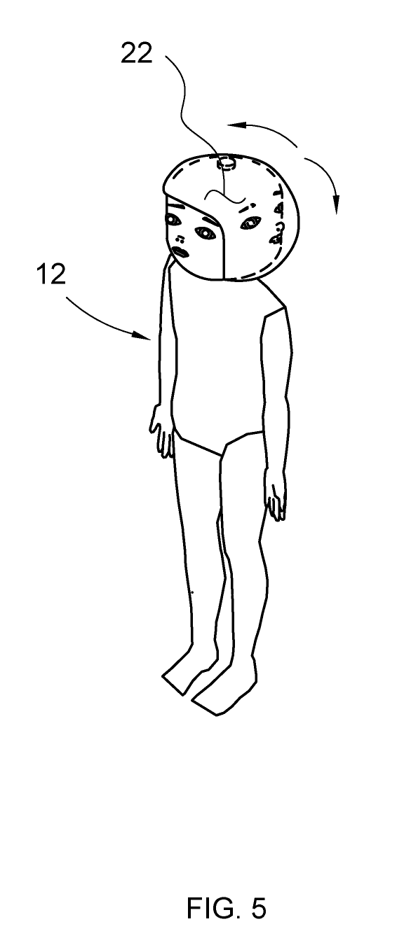

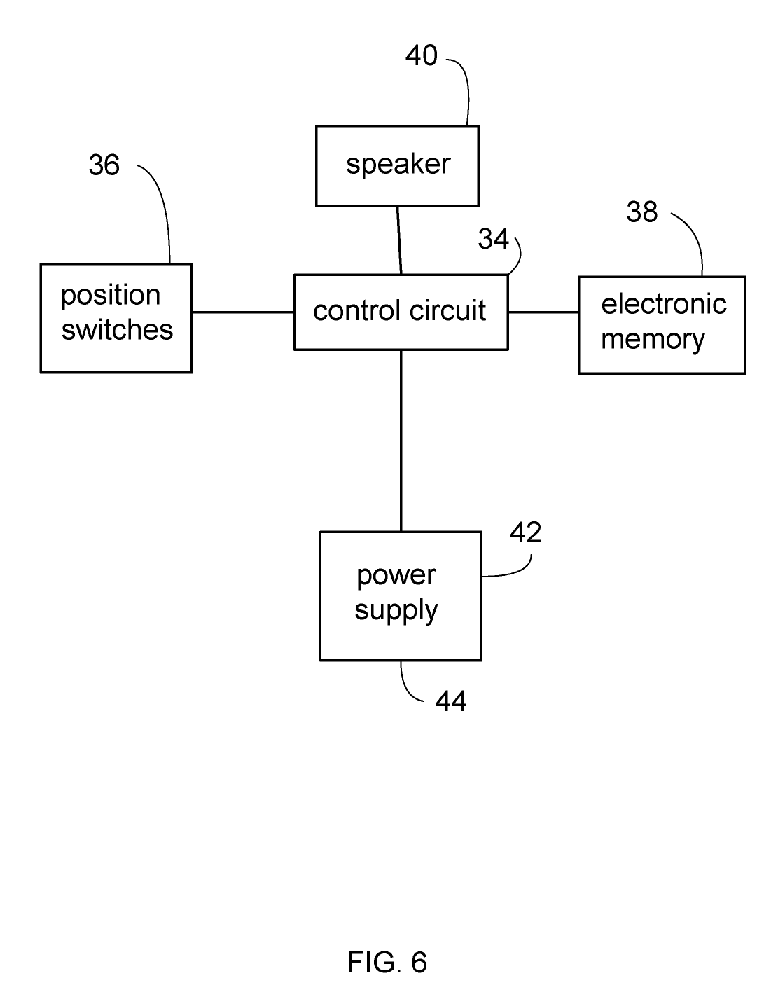

With reference now to the drawings, and in particular to FIGS. 1 through 6 thereof, a new doll device embodying the principles and concepts of an embodiment of the disclosure and generally designated by the reference numeral 10 will be described.

As best illustrated in FIGS. 1 through 6, the educational doll assembly 10 generally comprises a doll 12 that has a body 14, a neck 16 extending upwardly from the body 14 and a head 18 that is movably coupled to the neck 16. The doll 12 is structured to resemble a human being and the neck 16 extends upwardly into the head 18 such that the head 18 is rotatable about the neck 16. The neck 16 has an engagement 20 thereon and the head 18 has an outwardly facing surface 22. Moreover, the outwardly facing surface 22 has a plurality of faces 24 thereon and the faces 24 are spaced apart from each other and are distributed around the outwardly facing surface 22. Each of the faces 24 has eyes 26, a nose 28 and a mouth 30, and the eyes 26, nose 28 and mouth 30 corresponding to each of the faces 24 is structured to resemble different ethnicities of human beings. The head 18 is rotatable such that a selected one of the faces 24 is aligned with the body 14 of the doll 12.

An audio unit 32 is coupled to the doll 12 and the audio unit 32 emits audible sounds outwardly therefrom. The audio unit 32 stores a plurality of spoken words in a plurality of different human languages and the audio unit 32 is in communication with the head 18. The audio unit 32 emits the spoken words in a language corresponding to the ethnicity of the selected face 24 on the head 18 when the selected face 24 is aligned with the body 14. In this way the audio unit 32 may teach a user about the language spoken by the ethnicity on the selected face 24.

The audio unit 32 comprises a control circuit 34 that is positioned within the doll 12. A plurality of position switches 36 is each is positioned in the head 18 and each of the position switches 36 is aligned with one of the faces 24. The position switch 36 corresponding to the selected face 24 engages the engagement 20 on the neck 16 when the selected face 24 is aligned with the body 14. In this way the position switch 36 corresponding to the selected face 24 is turned on. Each of the position switches 36 is electrically coupled to the control circuit 34 and each of the position switches 36 is assigned an identity in the control circuit 34.

An electronic memory 38 is positioned within the doll 12 and the electronic memory 38 is electrically coupled to the control circuit 34. The electronic memory 38 stores data comprising the plurality of different languages. The data corresponding to each of the different languages is assigned an identity corresponding to the ethnicity of each of the faces 24. Additionally, the electronic memory 38 communicates the data corresponding to the ethnicity of the selected face 24 to the control circuit 34. The electronic memory 38 may be ROM or any other electronic data storage.

A speaker 40 is coupled to the doll 12 to emit audible sounds outwardly therefrom. The speaker 40 is electrically coupled to the control circuit 34 such that the speaker 40 emits spoken words in the language corresponding to the ethnicity of the selected face 24. Thus, the speaker 40 teaches a user the language spoken by the ethnicity of the selected face 24. A power supply 42 is positioned within the doll 12 and the power supply 42 is electrically coupled to the control circuit 34. The power supply 42 comprises at least one battery 44 and the power supply 42 may be positioned beneath a removable battery 44 cover on the doll 12.

In use, the head 18 is rotated to align a selected one of the faces 24 with a front of the body 14. The position switch 24 that is aligned with the selected face 24 engages the engagement 20 on the neck 16 when the selected face 24 is aligned with the front of the body 14. Thus, the control circuit 34 retrieves the data from the electronic memory 38 that corresponds to the ethnicity of the selected face 24. The speaker 40 emits the verbal phrases in the language corresponding to the ethnicity of the selected face 24. In this way the doll 12 can teach a child about different languages spoken by different people around the world.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An educational doll assembly being configured to speak one of a plurality of selected languages for teaching the selected language, said assembly comprising:
a doll having a body, a neck extending upwardly from said body and a head being movably coupled to said neck, said neck extending upwardly into said head such that said head is rotatable about said neck, said head having a plurality of faces thereon, each of said faces being structured to resemble different ethnicities of human beings, said head being rotatable such that a selected one of said faces is aligned with the body of the doll; and
an audio unit being coupled to said doll wherein said audio unit is configured to emit audible sounds outwardly therefrom, said audio unit storing a plurality of spoken words in a plurality of different languages, said audio unit being and communication with said head, said audio unit emitting the spoken words in a language corresponding to the ethnicity of the selected face on the head wherein said audio unit is configured to teach a user about the language spoken by the ethnicity on the selected face.

2. The assembly according to claim 1, wherein said neck has an engagement thereon, said head having an outwardly facing surface, said faces being spaced apart from each other and being distributed around said outwardly facing surface, each of said faces having eyes, a nose and a mouth, said eyes.

3. The assembly according to claim 2, wherein said audio unit comprises a control circuit being positioned within said doll.

4. The assembly according to claim 3, further comprising a plurality of position switches, each of said position switches being positioned in said head, each of said position switches being aligned with one of said faces.

5. The assembly according to claim 4, wherein:
said neck has an engagement being positioned thereon; and
said position switch corresponding to said selected face engages said engagement on said neck when said selected face is aligned with said body to turn on said position switch corresponding to said selected face, each of said position switches being electrically coupled to said control circuit, each of said position switches being assigned an identity in said control circuit.

6. The assembly according to claim 5, further comprising an electronic memory being positioned within said doll, said electronic memory being electrically coupled to said control circuit said electronic memory storing data comprising the plurality of different languages, said data corresponding to each of the different languages being assigned an identity corresponding to the ethnicity of each of said faces, electronic memory communicating the data corresponding to the ethnicity of said selected face to said control circuit.

7. The assembly according to claim 6, further comprising a speaker being coupled to said doll wherein said speaker is configured to emit audible sounds outwardly therefrom, said speaker being electrically coupled to said control circuit such that said speaker emits spoken words in the language corresponding to the ethnicity of said selected face wherein said speaker is configured to teach a user the language spoken by the ethnicity of said selected face.

8. The assembly according to claim 3, further comprising a power supply being positioned within said doll, said power supply being electrically coupled to said control circuit, said power supply comprising at least one battery.

9. An educational doll assembly being configured to speak one of a plurality of selected languages for teaching the selected language, said assembly comprising:
a doll having a body, a neck extending upwardly from said body and a head being movably coupled to said neck, said neck extending upwardly into said head such that said head is rotatable about said neck, said neck having a and engagement thereon, said head having an outwardly facing surface, said outwardly facing surface having a plurality of faces thereon, said faces being spaced apart from each other and being distributed around said outwardly facing surface, each of said faces having eyes, a nose and a mouth, said eyes, nose and mouth corresponding to each of said faces being structured to resemble different ethnicities of human beings, said head being rotatable such that a selected one of said faces is aligned with the body of the doll; and
an audio unit being coupled to said doll wherein said audio unit is configured to emit audible sounds outwardly therefrom, said audio unit storing a plurality of spoken words in a plurality of different languages, said audio unit being and communication with said head, said audio unit emitting the spoken words in a language corresponding to the ethnicity of the selected face on the head wherein said audio unit is configured to teach a user about the language spoken by the ethnicity on the selected face, said audio unit comprising:
a control circuit being positioned within said doll;
a plurality of position switches, each of said position switches being positioned in said head, each of said position switches being aligned with one of said faces, said position switch corresponding to said selected face engaging said engagement on said neck when said selected face is aligned with said body to turn on said position switch corresponding to said selected face, each of said position switches being electrically coupled to said control circuit, each of said position switches being assigned an identity in said control circuit;
an electronic memory being positioned within said doll, said electronic memory being electrically coupled to said control circuit said electronic memory storing data comprising the plurality of different languages, said data corresponding to each of the different languages being assigned an identity corresponding to the ethnicity of each of said faces, electronic memory communicating the data corresponding to the ethnicity of said selected face to said control circuit;
a speaker being coupled to said doll wherein said speaker is configured to emit audible sounds outwardly therefrom, said speaker being electrically coupled to said control circuit such that said speaker emits spoken words in the language corresponding to the ethnicity of said selected face wherein said speaker is configured to teach a user the language spoken by the ethnicity of said selected face; and
a power supply being positioned within said doll, said power supply being electrically coupled to said control circuit, said power supply comprising at least one battery.
